(19) United States
(12) Patent Application Publication
(10) Pub. No.: US 2009/0007809 A1
(43) Pub. Date: Jan. 8, 2009

(54) RUBBER STAMP PRODUCTION APPARATUS AND METHOD

(76) Inventors: LOUIS NGUYEN, Anaheim, CA (US); LISA NGUYEN, Anaheim, CA (US); DAVID NGUYEN, Garden Grove, CA (US); SERENA NGUYEN, Garden Grove, CA (US)

Correspondence Address: AVERILL & VARN, 8244 PAINTER AVE., WHITTIER, CA, 90602, US

(21) Appl. No.: 11/772,761

(22) Filed: Jul. 2, 2007

(51) Int. Cl. B41C 3/00

(52) U.S. Cl. 101/401.1; 425/174.4

(57) ABSTRACT

A simple and convenient apparatus and method for producing stamps using a photo polymer. A sandwich is constructed which includes a first ridged UV clear panel, a translucent sheet having a negative image, a first cover sheet, a pair of spacers framing the image, a quantity of liquid photo polymer filling the area over the image and between the spacers, a substrate film over the photo polymer filling, a second cover sheet, and a second ridged UV clear panel. The sandwich is held together by clamps and is placed over a raised UV window in a UV window box to selectively harden the photo polymer. Following initial hardening, excess photo polymer is washed away, the hardened photo polymer is immersed in an exposure mixture and placed over the UV window for final hardening. The raised UV window allows easy assembly of the sandwich and clearance for the clamps.

### BACKGROUND OF THE INVENTION

The present invention relates to making rubber stamps and in particular to an improved method for making rubber stamps from a photo polymer.

Rubber stamps are commonly used for business, personal, and hobby uses. Businesses and individuals commonly use return address stamps to simplify providing a return address on mail. Businesses often use stamps to date stamp incoming mail, or to stamp a preliminary draft of a letter or document accordingly. Stamps are also commonly used to place decorative images on cards, letters, or envelopes.

While stamps have long been available, custom stamps have required special ordering, and are often limited in content to common text or images selected from a catalog. Such stamps were neither quickly available, or adaptable to an individual's interests. More recently, stamps have been made at home or in small offices using a photo polymer and a UV light apparatus, but unfortunately, known UV light apparatus results in awkward and sometimes difficult handling of materials. In particular, known UV lights are housed in boxes having a flat surface for assembling and for laying a clamped assembly against. The flat surface does not allow easy grasping and room for the clamps.

### BRIEF SUMMARY OF THE INVENTION

The present invention addresses the above and other needs by providing a simple and inexpensive apparatus and method for producing stamps using a photo polymer. A sandwich is constructed over a raised UV window in a UV window box, which sandwich includes a first UV clear panel, a translucent sheet having a negative image, a first cover sheet, a pair of spacers on opposite sides of the image, a quantity of liquid photo polymer filling the area over the image and between the spacers, a substrate film over the photo polymer filling, a second cover sheet, and a second UV clear panel. The sandwich is held together by clamps and is placed over the raised UV window to selectively harden the photo polymer. Following initial hardening, excess photo polymer is washed away, the hardened photo polymer is immersed in an exposure mixture and placed over the UV window for final hardening. The raised UV window allows easy assembly of the sandwich and clearance for the clamps.

In accordance with one aspect of the invention, there is provided a method for producing a stamp. The method includes assembling a sandwich using steps of creating a negative image on a translucent sheet, placing a first UV clear panel on a horizontal surface, placing the translucent sheet on the first clear panel with the negative image facing upright, placing a first cover sheet over the translucent sheet, placing spacers on the first cover sheet positioned on opposite sides of the negative image, pouring a photo polymer over the first cover sheet between the spacers, placing a substrate film over the photo polymer with a rough side of the substrate film against the photo polymer and a smooth side of the substrate film away from the photo polymer, placing a second cover sheet over the substrate film, placing a second UV clear panel over the second cover sheet, and clamping the two UV clear panels together to form the sandwich. A partially hardened photo polymer is created by the steps of flipping the sandwich, positioning the sandwich over a raised UV window of a UV window box, turning on a UV light under the UV window for a first period of time, flipping the sandwich, positioning the sandwich over the raised UV window, and turning on the UV light for a second period of time to complete partial hardening of the photo polymer. The stamp is prepared for final hardening by steps of removing the clamps from the UV clear panels, removing the UV clear panels, removing the second cover sheet, removing the substrate sheet, washing the photo polymer with a water and detergent mixture, brushing the photo polymer to remove non-hardened photo polymer material, rinsing the washed photo polymer material, repeating the washing and rinsing until a stamp image is clear, placing the partially hardened photo polymer face down in a container containing a water and exposure powder mixture, placing the container containing the hardened photo polymer over the raised UV window and turning on the UV light for a third period of time to complete hardening of the photo polymer. The completed stamp is provided by the steps of removing the fully hardened photo polymer from the container, drying the fully hardened photo polymer; and trimming the fully hardened photo polymer to produce the stamp.

In accordance with another aspect of the invention, there is provided apparatus for producing a stamp. The apparatus includes a UV window box and a sandwich. The UV window box includes a housing, a raised UV window on a top surface of the housing above the UV light, at least one UV light residing in the housing under the raised UV window, a power source electrically connected to the UV light, and a timer controlling the connection of the power source to the UV light. The sandwich includes a first UV clear panel, a translucent sheet bearing a negative image, a first cover sheet residing over the translucent sheet, a pair of spacers residing on opposite sides of the negative image over the first cover sheet, a volume of a liquid photo polymer residing over the first cover sheet and between the spacers, a substrate film residing over the liquid photo polymer, a second cover sheet residing over the substrate film, a second UV clear panel residing over the second cover sheet, and clamps holding the UV clear panels together.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 shows apparatus and materials according to the present invention for producing photo polymer stamp pads.

FIG. 2 is a cross-sectional view of an Ultra Violet (UV) window box according to the present invention taken along line 2-2 of FIG. 1.

FIG. 3A describes a method according to the present invention for producing the photo polymer stamp pads.

FIG. 3B concludes the method according to the present invention for producing the photo polymer stamp pads.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

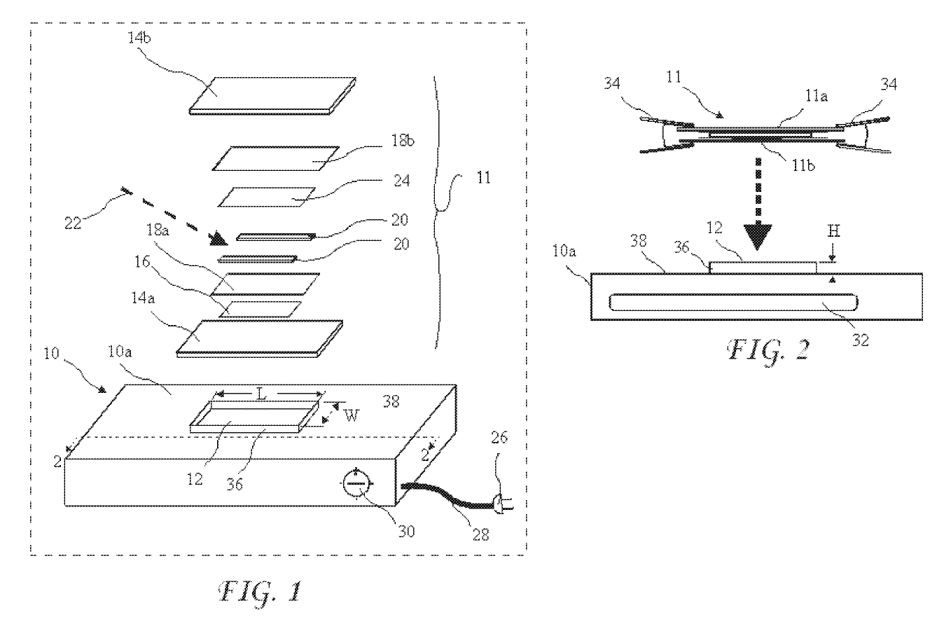

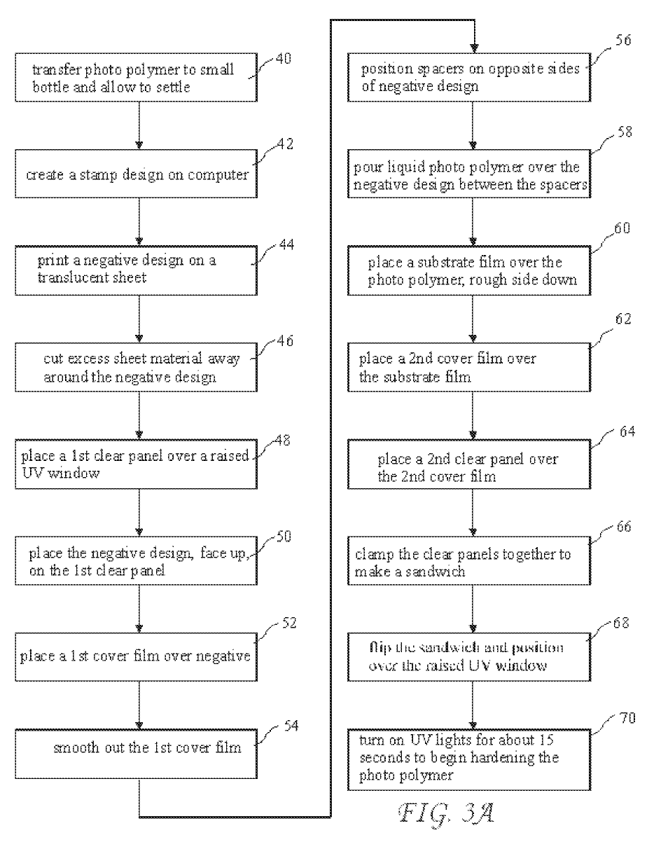

Apparatus and materials according to the present invention for producing photo polymer stamp pads are shown in an exploded view in FIG. 1 and a cross-sectional view of an Ultra Violet (UV) window box 10 according to the present invention taken along line 2-2 of FIG. 1 and a sandwich 11 is shown in FIG. 2. The UV window box 10 includes a housing 10a containing at least one UV light 32, and preferably containing two approximately 15 watt UV lights. A raised UV window 12 in the housing 10a is provided to allow UV light to escape. The raised UV window 12 has a length L between approximately four inches and approximately seven inches long and preferably approximately six inches, and a width W between approximately two inches and approximately four inches and preferably approximately three inches. The raised UV window 12 includes upward extending sides 36 which support the sandwich 11 having a height H between approximately ½ inches and approximately one inch above a top surface 38 of the housing 10a, and preferably approximately 0.7 inches above the top surface 38 of the housing 10a. This positioning above the top surface 38 advantageously provides space for the clamps 34 as well as facilitating the assembly, placement, and removal of the sandwich 11 from the raised window 36, for example, provides space for a user's fingers between the sandwich 11 and the top surface 38. The raised UV window 12 may include a clear glass cover or a cover made from any material which is transparent to UV light, or may be an opening with no cover.

A timer 30 controls power provided to the UV light 32 by a cord 28 and plug 26. A sandwich 11 is held together by clamps 34 and rests on the window 12 for timed exposure to UV light. Raising the window 12 allows space for the clamps 34 on the sandwich 11 to clear the top surface of the box 10 when the sandwich 11 is residing on the raised UV window 12. The sandwich 11 has a top surface 11a and a bottom surface 11b.

During initial phases of producing a photo polymer stamp, materials are stacked to form the sandwich 11 preferably including, from bottom to top, a first clear panel 14a, a translucent sheet 16 having a negative image, a first cover sheet 18a, spacers 20, a substrate film 24, a second cover sheet 18b, and a second clear panel 14b. The clear panels 14a, 14b should be sufficiently ridged to transfer the force from the clamps 34 to the photo polymer so that the thickness of the resulting stamp is controlled, for example, is the same thickness as the spacers 20. The panels 14a and 14b are preferably glass panels, but may be any ridged panel which is transparent, or sufficiently transparent to UV light. The negative on the translucent sheet 16 blocks UV light to create the stamp. The image may be hand drawn or computer generated, or any image which blocks UV light. The specific translucent sheet material used is selected for the type of printer used, for example, an ink jet printer or a laser printer. The cover sheets 18a and 18b may be any smooth transparent film.

The spacers 20 provides a volume for a liquid photo polymer 22 to be poured over the negative 16 and determine the thickness of the stamp produced from the photo polymer. An example of a suitable spacer is ¼ cm thick plastic. The spacers should be longer than the longest desired stamp, and are preferably approximately seven cm long, and approximately one cm wide. An example of a suitable liquid photo polymer 22 is 140 polymer made by Ideal in Piscataway, New Jersey.

The cover sheets 18a and 18b prevent material from becoming stuck to the clear panels 14a and 14b, and are not a necessary element of the sandwich 11.

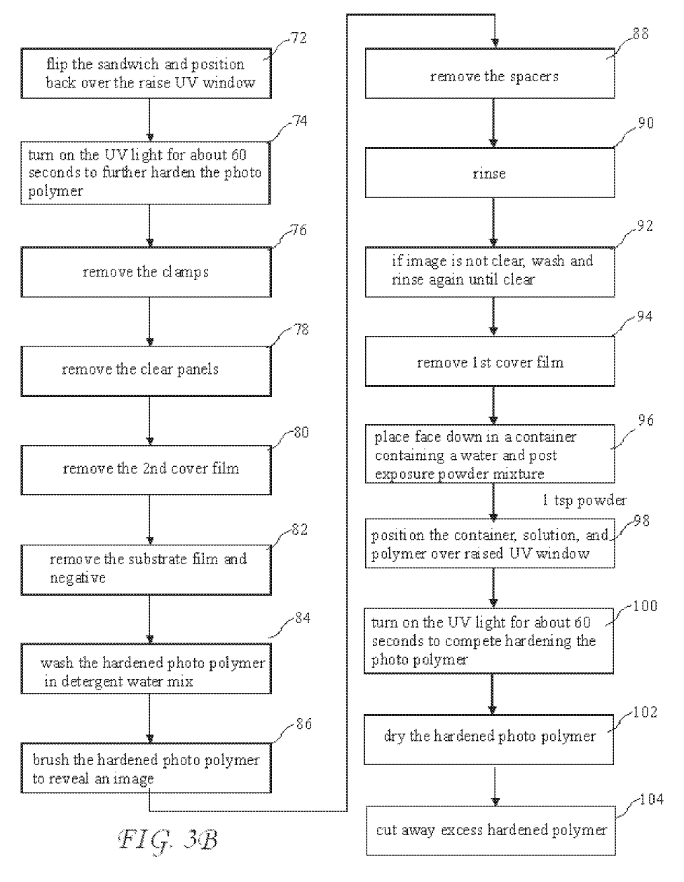

FIG. 3A describes a method according to the present invention for producing the photo polymer stamp pads. The method includes transferring liquid photo polymer to a small bottle for easier handling and allowed to settle for a settling time of preferably at least about five hours to allow bubbles to escape from the liquid photo polymer at step 40, create a stamp design on a computer at step 42, print a negative of the design on a translucent sheet at step 44, cutting away excess sheet material away around the negative design at step 46, place a first clear panel over a horizontal surface, preferably on the raised UV window 12, at step 48, place the negative design, face up, on the first clear panel at step 50, placing a first cover sheet over negative at step 52, smoothing out the first cover sheet at step 54, positioning spacers on opposite sides of negative design at step 56, pouring liquid photo polymer over the negative design between the spacers at step 58, placing a substrate film over the photo polymer, rough side down and smooth side up at step 60, placing a second cover sheet over the substrate film at step 62, placing a 2nd clear panel over the second cover film at step 64, clamping the clear panels together in a biased closed manner to make a sandwich at step 66, flipping the sandwich and position the sandwich over the raised UV window 12 with the negative image face down at step 68, and turn on UV lights for a first period of time of preferably about 15 seconds at step 70.

FIG. 3B concludes the method according to the present invention for producing the photo polymer stamp pads. The remaining steps include flipping the sandwich and positioning the sandwich back over the UV window with the negative image face up at step 72, turning on the UV light for a second period of time of preferably about 60 seconds to complete partial hardening of the photo polymer at step 74, removing the clips at step 76, removing the clear panels at step 78, removing the second cover sheet at step 80, removing the substrate film and the negative at step 82, washing the hardened photo polymer in a detergent water mixture at step 84, brushing the hardened photo polymer to reveal an image at step 86, remove the spacers at step 88, rinsing the hardened photo polymer at step 90, if the image is not clear, repeating washing and rinsing at step 92, remove the first cover sheet at step 94, placing the hardened photo polymer, negative face down, in a water and post exposure powder mixture at step 96, placing the container, solution, and hardened photo polymer over the UV window, turning on the UV light for a third period of time of preferably about 60 seconds to compete hardening the photo polymer at step 100, drying the hardened photo polymer at step 102, and cutting away excess hardened photo polymer material at step 104.

The method of FIG. 3A and 3B may be altered to skip step 50 and to form the sandwich with the negative design placed face down over the second cover film after step 62, and the resulting sandwich may be placed on the raised UV window without flipping. In either case, the sandwich is placed over the raised UV window with the negative image face down for the first hardening step and face up for the second hardening step

While most users are likely to create a negative image on a translucent sheet using a computer, the negative image may also be created by drawing, a photographic process, a copying machine, or any other method allowing a UV light blocking negative image to be created on a UV translucent sheet.

The spacers preferably remain attached to the hardened polymer while washing the hardened photo polymer to make holding easier during washing, and to somewhat protect the hardened photo polymer from tearing or warping, but the spacers may be removed before washing.

An example of a suitable post exposure powder, in particular for use with I-Series photo polymer made by Ideal, is iPXC-A post exposure powder. Preferably, iPXC-B post exposure powder is added to the iPXC-A post exposure powder to reduce or eliminate tacking on the surface of the rubber.

25] In all cases, terms describing clear, translucent, or any other characteristic referring to the ability of light to pass through a material, is herein assumed to refer to the ability of UV light to pass through a material. Further, while a method using a UV window box 10 (See FIGS. 1 and 2) was described above, any UV light source may be used as long as the exposure of the liquid photo polymer 22 to the UV light is controlled. The times recited for exposure to UV light assume new materials. When old materials are used, for example, old exposure liquids, a longer UV exposure may be required. Further, the first exposure time and the second exposure time may be adjusted to adjust the depth of the solid image, and a longer first exposure time will result in a deeper image.

While the invention herein disclosed has been described by means of specific embodiments and applications thereof, numerous modifications and variations could be made thereto by those skilled in the art without departing from the scope of the invention set forth in the claims.

I claim:

1. A method for producing a stamp, the method comprising:
creating a negative image on a translucent sheet;
constructing a sandwich, the constructing comprising one of a first set of steps comprising:
placing a first ridged UV clear panel on a horizontal surface;
placing the translucent sheet with the negative image facing upright on the first UV clear panel;
placing spacers over the translucent sheet positioned on opposite sides of the negative image;
pouring a photo polymer over the translucent sheet between the spacers;
placing a substrate film over the photo polymer with a rough side of the substrate film against the photo polymer and a smooth side of the substrate film away from the photo polymer;
placing a second ridged UV clear panel over the substrate film; and
clamping the two ridged UV clear panels together to form a sandwich;
and a second set of steps comprising:
placing a first ridged UV clear panel on a horizontal surface;
placing spacers over the translucent sheet positioned on opposite sides of the negative image;
pouring a photo polymer over the translucent sheet between the spacers;
placing a substrate film over the photo polymer with a rough side of the substrate film against the photo polymer and a smooth side of the substrate film away from the photo polymer;
placing the translucent sheet with the negative image facing down on the substrate film;
placing a second ridged UV clear panel over the substrate film; and
clamping the two ridged UV clear panels together to form a sandwich;
placing the sandwich over a raised UV window so that the negative image in facing down;
turning on a UV light for a first period of time to initially harden the photo polymer;
placing the sandwich over a raised UV window so that the negative image in facing upward;
turning on the UV light for a second period of time to further harden the photo polymer to produce a partially hardened photo polymer;
removing the clamps from the ridged UV clear panels;
removing the ridged UV clear panels;
removing the substrate sheet;
cleaning non-hardened polymer from the partially hardened photo polymer;
placing the partially hardened photo polymer face down in a container containing an exposure mixture;
placing the container on the raised UV window;
turning on the UV light for a third period of time to fully harden the partially hardened photo polymer;
removing the hardened photo polymer from the container;
drying the hardened photo polymer; and
trimming the hardened photo polymer to produce the stamp.

2. The method of claim 1, wherein placing a first ridged UV clear panel on a horizontal surface comprises placing the first ridged UV clear panel on the raised UV window.

3. The method of claim 1, further including placing a first cover sheet over the negative and placing a second cover sheet over the substrate film.

4. The method of claim 1, wherein cleaning non-hardened polymer from the hardened photo polymer comprises:
washing the photo polymer with a water and detergent mixture;
brushing the photo polymer to remove non-hardened photo polymer material;
rinsing the washed photo polymer material; and
repeating the washing and rinsing until a stamp image is clear.

5. The method of claim 4, wherein washing the photo polymer with a water and detergent mixture comprises washing the photo polymer, while holding the hardened photo polymer in place by holding the spacers, with a water and detergent mixture

6. The method of claim 1, further including removing the spacers before trimming the hardened photo polymer.

7. The method of claim 1, wherein exposing a top surface of the sandwich to a UV light for a first period of time comprises exposing the top surface of the sandwich to UV light for approximately 15 seconds.

8. The method of claim 1, wherein turning on the UV light for a second period of time comprises turning on the UV light for approximately 60 seconds.

9. The method of claim 1, wherein turning on the UV light for a third period of time comprises turning on the UV light for approximately 60 seconds.

10. The method of claim 1, wherein exposing to UV light comprises positioning over a raised UV window and turning on a UV light under the window.

11. The method of claim 1, wherein the ridged UV clear panels are glass panels.

12. The method of claim 1, wherein creating a negative image comprises printing a negative image on the translucent sheet using a computer printer.

13. Apparatus for producing a stamp:
A UV window box comprising:
a housing;
a raised UV window between approximately four inches and approximately seven inches long, between approximately two inches and approximately four inches wide, and between approximately ½ inches and approximately one inch above a top surface of the housing for supporting an object being exposed to UV light;
at least one UV light residing in the housing under the raised UV window; and
a power source electrically connected to the UV light; and
a sandwich comprising:
a first ridged UV clear panel;
a translucent sheet bearing a negative image;
a first cover sheet residing over the translucent sheet;
a pair of spacers residing on opposite sides of the negative image over the first cover sheet;
a volume of a liquid photo polymer residing over the first cover sheet and between the spacers;
a substrate film residing over the liquid photo polymer;
a second cover sheet residing over the substrate film;
a second ridged UV clear panel residing over the second cover sheet; and
clamps holding the ridged UV clear panels together.

14. The apparatus of claim 13, wherein the raised UV window is approximately 0.7 inches above the top surface of the housing.

15. The apparatus of claim 13, wherein the raised UV window is approximately six inches long and approximately three inches wide.

16. The apparatus of claim 13, further including a timer electrically connected between the power source and the UV light.

17. A method for producing a stamp, the method comprising:
creating a negative image on a translucent sheet;
constructing a sandwich, the constructing comprising one of a first set of steps comprising:
placing a first ridged UV clear panel on a raised UV window between approximately one half and approximately one inch above a top surface of a UV window box housing;
placing the translucent sheet with the negative image facing upright on the first UV clear panel;
placing spacers over the translucent sheet positioned on opposite sides of the negative image;
pouring a photo polymer over the translucent sheet between the spacers;
placing a substrate film over the photo polymer with a rough side of the substrate film against the photo polymer and a smooth side of the substrate film away from the photo polymer;
placing a second ridged UV clear panel over the substrate film; and
clamping the two ridged UV clear panels together to form a sandwich;
and a second set of steps comprising:
placing a first ridged UV clear panel on a horizontal surface;
placing spacers over the translucent sheet positioned on opposite sides of the negative image;
pouring a photo polymer over the translucent sheet between the spacers;
placing a substrate film over the photo polymer with a rough side of the substrate film against the photo polymer and a smooth side of the substrate film away from the photo polymer;
placing the translucent sheet with the negative image facing down on the substrate film;
placing a second ridged UV clear panel over the substrate film; and
clamping the two ridged UV clear panels together to form a sandwich;
placing the sandwich over a raised UV window so that the negative image in facing down;
turning on a UV light for a first period of time to initially harden the photo polymer;
placing the sandwich over a raised UV window so that the negative image in facing upward;
turning on the UV light for a second period of time to further harden the photo polymer to produce a partially hardened photo polymer;
removing the clamps from the ridged UV clear panels;
removing the ridged UV clear panels;
removing the second cover sheet;
removing the substrate sheet;
washing the photo polymer with a water and detergent mixture;
brushing the photo polymer to remove non-hardened photo polymer material;
rinsing the washed photo polymer material;
repeating the washing and rinsing until a stamp image is clear;
placing the partially hardened photo polymer face down in a container containing a water and exposure powder mixture;
placing the container containing the hardened photo polymer over the raised UV window;
turning on the UV light for a third period of time to complete hardening of the photo polymer;
removing the fully hardened photo polymer from the container;
drying the fully hardened photo polymer; and
trimming the fully hardened photo polymer to produce the stamp.

18. The method of claim 17, wherein placing a first ridged UV clear panel between approximately one half and approximately one inch above a top surface of a UV window box housing on a raised UV window comprises placing the first ridged UV clear panel approximately 0.7 inches above the top surface of the UV window box housing on the raised UV window.

19. The method of claim 18, wherein placing the first ridged UV clear panel approximately 0.7 inches above the top surface of the UV window box housing on the raised UV window comprises placing the first ridged UV clear panel on the raised UV window between approximately four inches and approximately seven inches long and between approximately two inches and approximately four inches wide.

20. The method of claim 19, wherein placing the first ridged UV clear panel on the raised UV window between approximately four inches and approximately seven inches long and between approximately two inches and approximately four inches wide comprises placing the first ridged UV clear panel on the raised UV window approximately six inches long and approximately three inches wide.
